(19) United States
(12) Patent Application Publication
(10) Pub. No.: US 2018/0044529 A1
(43) Pub. Date: Feb. 15, 2018

(54) POLYMERIZED OILS & METHODS OF MANUFACTURING THE SAME

(71) Applicant: Cargill, Incorporated, Wayzata, MN (US)

(72) Inventors: Todd L. KURTH, Maple Grove, MN (US); Frank LOCHEL, Delano, MN (US); Suzanne STAUDUHAR, Robbinsdale, MN (US); Hassan TABATABAEE, Plymouth, MN (US)

(21) Appl. No.: 15/558,000

(22) PCT Filed: Mar. 11, 2016
(86) PCT No.: PCT/US16/22035

§ 371 Date: Sep. 13, 2017

Related U.S. Application Data
(60) Provisional application No. 62/133,010, filed on Mar. 13, 2015.

(51) Int. Cl. C08L 95/00; C08F 22/10

(52) U.S. Cl. CPC C08L 95/005; C08F 22/105; C08L 2555/28; C08L 2555/80; C08L 2555/82; C08L 2205/02; C08L 2555/34

(57) ABSTRACT

Described herein is a polymerized petroleum based or biorenewable oil obtain by blowing and an optional stripping process, comprising a polymeric distribution having about 2 to about 80 wt % oligomer content and a polydispersity index ranging from about 1.0 to about 20.0. Methods of manufacturing the polymerized oil as well as its incorporation into asphalt, roofing, and coating applications are also described.

### TECHNICAL FIELD

This disclosure relates to polymerized oils and methods for polymerizing oils and blending with asphalt to enhance performance of virgin asphalt and/or pavements containing recycled and aged bituminous material.

### BACKGROUND

Recent technical challenges facing the asphalt industry have created opportunities for the introduction of agriculture-based products for the overall performance enhancement of asphalt. Such performance enhancements may include, for example but aren't limited to, expanding the useful temperature index (UTI) of asphalt, rejuvenating aged asphalt, and compatibilizing elastomeric thermoplastic polymers in asphalt, and warm mix applications.

### SUMMARY

Aspects described herein provide a polymerized petroleum-based or biorenewable oil obtain by blowing and an optional stripping process, comprising a polymeric distribution having about 2 to about 80 wt % oligomer content and a polydispersity index ranging from about 1.0 to about 20.0. Methods of manufacturing the polymerized oil as well as its incorporation into asphalt, roofing, and coating applications are also described.

### BRIEF DESCRIPTION OF DRAWINGS

FIG. 1 shows fine and uniform distribution of SBS polymer in the bitumen after addition of modifier as a compatibilizer compared to a blend not containing a compatibilizer.

### DETAILED DESCRIPTION

“Acid Value” (AV) is a measure of the residual hydronium groups present in a compound and is reported in units of mg KOH/gram material. The acid number is measured according to the method of AOCS Cd 3d-63.

“Flash Point” or “Flash Point Temperature” is a measure of the minimum temperature at which a material will initially flash with a brief flame. It is measured according to the method of ASTM D-92 using a Cleveland Open Cup and is reported in degrees Celsius (° C.).

“Hildebrand Solubility” parameter is defined as the square root of the cohesive energy density, which is the heat of vaporization divided by the molar volume. The degree of similarity in the value of this parameter between different materials provides a description of the degree of interaction resulting in miscibility, solvency, or swelling behavior. In this system substances with similar Hildebrand solubility parameters have a higher miscibility. The Hildebrand solubility parameter can be related or correlated with a number of experimentally derived properties, such as the refractive index. In the present document the Hildebrand solubility parameter was estimated through utilization of the following relationship, in which δ is the Hildebrand solubility parameter and RI is the refractive index: δ=9.55 RI-5.55

“Oligomer” is defined as a polymer having a number average molecular weight (Mn) larger than 1000. A monomer makes up everything else and includes monoacylgyclerides (MAG), diacylglycerides (DAG), triacylglycerides (TAG), and free fatty acids (FFA).

“Performance Grade” (PG) is defined as the temperature interval for which a specific asphalt product is designed. For example, an asphalt product designed to accommodate a high temperature of 64° C. and a low temperature of −22° C. has a PG of 64-22. Performance Grade standards are set by the National Committee of Highway and Roadway Professionals (NCHRP).

“Polydispersity Index” (also known as “Molecular Weight Distribution”) is the ratio of weight average molecular weight (Mw) to number average molecular weight (Mn). The polydispersity data is collected using a Gel Permeation Chromatography instrument equipped with a Waters 510 pump and a 410 differential refractometer. Samples are prepared at an approximate 2% concentration in a THF solvent. A flow rate of 1 ml/minute and a temperature of 35° C. are used. The columns consist of a Phenogel 5 micron linear/mixed Guard column, and 300×7.8 mm Phenogel 5 micron columns (styrene-divinylbenzene copolymer) at 50, 100, 1000, and 10000 Angstroms. Molecular weights were determined using the following standards:

| | | | Arcol | | Epoxidized | | | |
|---|---|---|---|---|---|---|---|---|
| | | | LHT | | Soybean | Acclaim | Multranol | Acclaim |
| Standard | Monoolein | Diolein | 240 | Triolein | Oil | 2200 | 3400 | 8200 |
| Molecular | 356 | 620 | 707 | 878 | 950 | 2000 | 3000 | 8000 |
| Weight | | | | | | | | |
| (Daltons) | | | | | | | | |

“Useful Temperature Interval” (UTI) is defined as the interval between the highest temperature and lowest temperature for which a specific asphalt product is designed. For example, an asphalt product designed to accommodate a high temperature of 64° C. and a low temperature of −22° C. has a UTI of 86. For road paving applications, the seasonal and geographic extremes of temperature will determine the UTI for which an asphalt product must be designed. UTI of asphalt is determined by a series of AASHTO and ASTM standard tests developed by the Strategic Highway Research Program (SHRP) also known as the “Performance Grading” (PG) specification.

### Asphalt and Bituminous Materials

For the purpose of this invention, asphalt, asphalt binder, and bitumen refer to the binder phase of an asphalt pavement. Bituminous material may refer to a blend of asphalt binder and other material such as aggregate or filler. The binder used in this invention may be material acquired from asphalt producing refineries, flux, refinery vacuum tower bottoms, pitch, and other residues of processing of vacuum tower bottoms, as well as oxidized and aged asphalt from recycled bituminous material such as reclaimed asphalt pavement (RAP), and recycled asphalt shingles (RAS).

For the purpose of this invention, emulsion is defined as a multiphase material in which all phases are dispersed in a continuous aqueous phase. The aqueous phase may be comprised of surfactants, acid, base, thickeners, and other additives. The dispersed phase may comprise of the polymerized oil, thermoplastic natural and synthetic polymers, waxes, asphalt, and other additives and oils, herein collectively referred to as the “oil phase”. High shear and energy is often necessary to disperse the oil phase in the aqueous phase using apparatus such as colloidal mills.

### Starting Petroleum-Based or Biorenewable Oils

Petroleum based or biorenewable oils may be used as the starting oil material.

Petroleum based oil includes a broad range of hydrocarbon-based compositions and refined petroleum products, having a variety of different chemical compositions which are obtained from recovery and refining oils of fossil based original and considered non-renewable in that it takes millions of year to generate crude starting material.

Biorenewable oils can include oils isolated from plants, animals, and microorganisms including algae.

Plant-based oils that can be utilized in the invention include but are not limited to soybean oil, linseed oil, canola oil, rapeseed oil, cottonseed oil, sunflower oil, palm oil, peanut oil, safflower oil, corn oil, corn stillage oil (recovered corn oil RCO), lecithin (phospholipids) and combinations and crude streams thereof or co-products, by-products, or residues resulting from oil refining processes.

Examples of animal-based oils may include but are not limited to animal fat (e.g., lard, tallow) and lecithin (phospholipids), and combinations and crude streams thereof.

Biorenewable oils can also include partially hydrogenated oils, oils with conjugated bonds, and bodied oils wherein a heteroatom is not introduced, for example but not limited to, diacylglycerides, monoacylglycerides, free fatty acids, alkyl esters of fatty acids (e.g., methyl, ethyl, propyl, and butyl esters), diol and triol esters (e.g., ethylene glycol, propylene glycol, butylene glycol, trimethylolpropane), and mixtures thereof. An example of biorenewable oils may be waste cooking oil or other used oils.

Biorenewable oils can also include derivatives thereof, for example, previously modified or functionalized oils (intentional or unintentional) wherein a heteroatom (oxygen, nitrogen, sulfur, and phosphorus) has been introduced may also be used as the starting oil material. Examples of unintentionally modified oils are used cooked oil, trap grease, brown grease, or other used industrial oils. Examples of previously modified oils are those that have been previously vulcanized or polymerized by other polymerizing technologies, such as maleic anhydride or acrylic acid modified, hydrogenated, dicyclopentadiene modified, conjugated via reaction with iodine, interesterified, or processed to modify acid value, hydroxyl number, or other properties. Such modified oils can be blended with unmodified plant-based oils or animal-based oils, fatty acids, glycerin, and/or gums materials.

In preferred aspects, the starting oil material is recovered corn oil (also be referred to as “corn stillage oil”) which is typically a form of residual liquid resulting from the manufacturing process of turning corn into ethanol. In another preferred aspect, the starting oil material comprises free fatty acids. One skilled in the art will recognize that if higher functionality is desired, petroleum based or biorenewable oils having higher levels of unsaturation may be used. Conversely higher saturates may be incorporated to further vary solvent parameters of the polymerized oils to improve performance properties in asphalt.

### Blowing and Optional Stripping of the Petroleum Based or Biorenewable Oil

The petroleum based or biorenewable oil is heated to at least about 90° C., and preferably from about 100° C. to about 115° C. It shall be understood that this heating temperature may increase to achieve faster polymerization, for example greater than 160° C.

Additives, initiators, catalysts, or combinations thereof, may be added to the petroleum based or biorenewable oil. Additives such as lecithin and/or additional fatty acids may be added to the petroleum based or biorenewable oil before or during the heating step. The use of additives may aid in reduction of costs associated with the petroleum based or biorenewable oil while at the same time providing additional benefit of surfactancy and thus superior application performance, specifically benefiting emulsifiability, anti-strip, and warm mix lubricity. Initiators such as peroxide or tung oil may be added to the petroleum based or biorenewable oil before or during the heating step.

A base metal catalyst also may be added to the petroleum based or biorenewable oil before or during the heating step to aid in the subsequent blowing step. If a base metal catalyst is used, it comprises a transition metal, and the transition metal is selected from the group consisting of cobalt, iron, zirconium, lead, and combinations thereof. The base metal catalyst may be added in amounts ranging from 200-1000 ppm.

In another aspect, accelerators may also be added to the petroleum based or biorenewable oil. For example, oxidizing chemicals, such as persulfates and permanganates, may be added to the petroleum based or biorenewable oil. In the presence of oxygen (from the oxygen containing stream, described below), these oxidizers (which promote oxidation) accelerate oxidative polymerization.

Subsequent to the heating step is a blowing step. Blowing is typically achieved by passing or exposing an oxygen containing stream through or to, respectively, the heated petroleum based or biorenewable oil or a composition comprising the petroleum based or biorenewable oil and other components (e.g., additives, initiators, catalysts). It shall be understood however that other processes that enable oxidation may be used as well to achieve a similar result as the blowing process. The vessel containing the petroleum based or biorenewable oil during the blowing step typically operates at atmospheric pressure. The pressure of the oxygen containing stream being blown through the oil is generally high enough to achieve the desired air flow through the petroleum based or biorenewable oil. The oxygen containing stream is introduced at a sufficient flow rate for a sufficient period of time to achieve the desired viscosity. Typically, the oxygen containing stream is introduced into the petroleum based or biorenewable oil at a rate of from about 40 to 450 cubic feet per minute. Preferably, the oxygen containing stream is dispersed evenly in the vessel to maximize surface area exposure. Typically, the vessel will have a distribution ring or spoke-like header to create small volume bubbles evenly within the oil. The duration of blowing the oxygen containing stream through the oil is varied and determined according to the desired properties of the blown oil and the end-use application for the resulting product.

In one aspect, the oxygen containing stream is an oxygen enriched stream derived from air. In another aspect, the oxygen containing stream comprises air. In yet another aspect, the oxygen containing stream comprises hydrogen peroxide.

The blowing reaction may continue and may be monitored using gel permeation chromatography (GPC) and/or viscosity until the desired degree of polymerization is achieved as discussed below.

The use of metal containing catalysts such as Cobalt in the blowing step is desirable, not only for acceleration of the increase in molecular weight, but also in the polymer distribution in the final product. It has been discovered that at an equal average molecular weight, the use of the metal containing catalyst promotes formation of larger molecular weight polymers and consequently a higher polydispersity index, compared to that of a blown petroleum based or biorenewable oil in which a metal containing catalyst was not used. This aspect of the use of a metal containing catalyst is of significant importance, as the inventors have found that increasing the polydispersity contributes to an increase in the performance of the product as a rheology modifier and aged asphalt rejuvenator.

If desired, an optional stripping step may take place subsequent to blowing to assist in reducing acid value, increasing molecular weight, increasing flash point—all of which contribute to superior overall asphalt performance. The blown petroleum based or biorenewable oil can be stripped using a nitrogen sparge and, optionally, under vacuum conditions.

Before the blown petroleum based or biorenewable oil is stripped, however, a base metal catalyst may be added to the blown petroleum based or biorenewable oil to enhance the stripping step. In preferred aspects, the base metal catalyst is added in an amount ranging from 250-1200 ppm, and more preferably ranging from 900-1100 ppm. The amount of catalyst is controlled in such a way to provide the optimum level of fatty soaps in the final product.

In one aspect, the base metal catalyst comprises metal selected from the group consisting of monovalent metals, divalent metals, and combinations thereof as described in the IUPAC Periodic Table of Elements (2013). In other aspects, the base metal catalyst comprises metals selected from the group consisting of potassium, calcium, sodium, magnesium and mixtures thereof. In preferred aspects, the base metal catalyst is potassium hydroxide. However, the catalyst added to prepare the blown petroleum based or biorenewable oil before the stripping step is not the same as the catalyst added to the petroleum based or biorenewable oil before the blowing step.

Typically, the temperature during the stripping step ranges from about 230° C. to about 350° C., and in some aspects from 230° C. to about 270° C., and in other aspects from about 235° C. to about 245° C.

During the initial stages of the stripping step, bodying reactions may also take place. Notably, after a petroleum based or biorenewable oil is blown, it may carry with it dissolved oxygen and residual peroxides. These peroxides continue to react via oxidative polymerization as the fluid is heated until the existing supply of peroxide is consumed or decomposed by the elevated temperature. A nitrogen sparge is preferably introduced with a sparge rate high enough to assist in the removal of the volatiles. In some aspects, a vacuum can be used during the stripping step. The sparge rate is maintained on the oil to assist in the removal of volatiles from the oil, including water that may be liberated by the reaction of glycerin with fatty acids (when polyols are added to the stripping step, which is further described below). Once the acid value has been reduced to the desired value, the heat may be removed if the desired viscosity has been obtained. If the desired viscosity has not been reached, the oil can continue to be heated until the desired value for viscosity is obtained. After the desired degree of polymerization has been obtained, the blown, stripped petroleum based or biorenewable oil may be cooled.

The inventors have surprisingly discovered that by adding a polyol to the blown oil the blown oil may be more easily stripped to obtain a blown, stripped petroleum based or biorenewable oil having a high viscosity and a low acid value as described above, which resulted in a blown, stripped petroleum based or biorenewable oil having a high flash point and superior asphalt performance (e.g., reducing short term age hardening and volatile mass loss leading to enhanced UTI improvement, mitigation of deleterious interactions with asphalt additives, etc.).

### Polymerization Characteristics

The blowing and optional stripping reaction described above is driven until a polymeric distribution having between about 2 wt % and about 80 wt % oligomers (20 wt % to 98 wt % monomers), and more preferably between about 15 wt % to about 60 wt % oligomers (40 wt % to 85 wt % monomers), and even more preferably between about 20 wt % to about 60 wt % oligomers (40 wt % to 80 wt % monomers) is achieved. In even more preferred aspects, the polymeric distribution ranges from about 50 wt % to about 75 wt % oligomers and about 25 wt % to about 50 wt % monomers.

The polydispersity index of the polymerized oil ranges from about 1.0 to about 20, in some aspects from about 1.10 to about 12.0, in some aspects from about 1.20 to 3.50, and in other aspects from about 1.50 to about 5.0.

The flash point of the resulting polymerized oil, as measured using the Cleveland Open Cup method, is at least about 100° C. and no more than about 400° C. In some aspects, the flash point of the polymerized oil is between about 200° C. and about 350° C. In other aspects, the flash point of the polymerized oil is between about 220° C. and about 300° C. In yet other aspects, the flash point of the polymerized oil is between about 245° C. and about 275° C. The polymerized oils described herein increase the flash point of the starting oil, especially at higher levels of polymerization.

The viscosity of polymerized oil will vary based on the type of starting oil material, but generally ranges from about 1 cSt to about 100 cSt at 100° C. Furthermore, the Hildebrand solubility parameter of the polymerized oil can range from about 6 to about 12.

### End-Use Applications

In one aspect, the present invention provides a modified asphalt comprising a blend of 60 wt % to 99.9 wt % of asphalt binder and 0.1 wt % to 40 wt % of the polymerized oil, and a method for making the same, in which polymerization of the oil is achieved through the blowing and optional stripping method as described above. The modified asphalt may be used for road paving or roofing applications. Additionally, modified asphalt can be used in a variety of industrial applications, not limited to coatings, drilling applications, and lubricants.

In another aspect, the present invention provides a modified asphalt comprising a blend of 60 wt % to 99.9 wt % asphalt binder and 0.1 wt % to 40 wt % of the polymerized oil, and a method for making the same, wherein the polymerized oil is a blend of an polymerized oil achieved through the blowing and optional stripping method, as described above, and one or more of the petroleum based or biorenewable oils described above, for example: unmodified plant-based oil, animal-based oil, fatty acids, fatty acid methyl esters, gums or lecithin, and gums or lecithin in modified oil or other oil or fatty acid.

Other components, in addition to the polymerized oil, may be combined with the asphalt binder to produce a modified asphalt, for example but not limited to, thermoplastic elastomeric and plastomeric polymers (styrene butadiene styrene, ethylene vinyl acetate, functionalized polyolefins, etc.), polyphosphoric acid, anti-stripping additives (amine-based, phosphate-based, etc.), warm mix additives, emulsifiers and/or fibers. Typically, these components are added the asphalt binder/polymerized oil at doses ranging from about 0.1 wt % to about 10 wt %.

### Asphalt Modification

The declining quality of bitumen drives the need for adding chemical modifiers to enhance the quality of asphalt products. Heavy mineral oils from petroleum refining are the most commonly used modifiers. These mineral oils extend the low temperature limit of the asphalt product by ‘plasticizing’ the binder, however this also tends to lower the upper temperature limit of the asphalt.

Mineral flux oils, petroleum-based crude distillates, and re-refined mineral oils have been used in attempts to soften the asphalt. Often, use of such material results in a decrease of the high temperature modulus of asphalt more than the low temperature, making the asphalt more prone of rutting at high temperatures. Such effects result in the reduction of the Useful Temperature Index (UTI).

Mineral flux oils, petroleum-based crude distillates, and re-refined mineral oils often have volatile fractions at pavement construction temperatures (e.g., 150 to 180° C.), generally have lower flashpoints than that of asphalt, and may be prone to higher loss of performance due to oxidative aging.

The polymerized oils and blends described herein are not only viable substitutes for mineral oil, but have also been shown to extend the UTI of asphalts to a greater degree than other performance modifiers, therefore providing substantial value to asphalt manufacturers. The observed increase in UTI using the polymerized oils described herein is a unique property not seen in other asphalt softening additives such as asphalt flux, fuel oils, products based on aromatic or naphthenic distillates, or flush oils. Typically one grade improvement in either the SHRP Performance Grading (PG) specification or the Penetration grading system used in many countries is achieved with approximately 2 to 3 wt % of the polymerized oil by weight of the asphalt. For example, the increase in UTI seen for approximately 3% by weight addition of the polymerized oil can be as much as 4° C., therefore providing a broader PG modification range such that the lower end temperature can be lower without sacrificing the higher end temperature.

### Rejuvenation of Aged Bituminous Material

Asphalt “ages” through a combination of mechanisms, mainly oxidation and volatilization. Aging increases asphalt modulus, decreases viscous dissipation and stress relaxation, and increases brittleness at lower performance temperatures. As a result, the asphalt becomes more susceptible to cracking and damage accumulation. The increasing usage of recycled and reclaimed bituminous materials which contain highly aged asphalt binder from sources such as reclaimed asphalt pavements (RAP) and recycled asphalt shingles (RAS) have created a necessity for “rejuvenators” capable of partially or completely restoring the rheological and fracture properties of the aged asphalt. The use of the polymerized oil described herein are particularly useful for RAP and RAS applications.

During plant production the asphalt is exposed to high temperatures (usually between 150 to 190° C.) exposure to air during which significant oxidation and volatilization of lighter fractions can occur leading to an increase in modulus and a decrease in viscous behavior. The aging process is simulated using a Rolling Thin Film Oven (ASTM D2872) during which a rolling thin film of asphalt is subjected a jet of heated air at about 163° C. for about 85 minutes. The rheological properties are measured before and after the aging procedure using a Dynamic Shear Rheometer following ASTM D7175 using the ratio of the complex modulus to the sin of the phase angle (|G*|/sin δ) after and before aging. A larger the ratio of the (|G*|/sin δ) after aging to the (|G*|/sin δ) before aging, the higher the effect of oxidative aging and volatilization on the tested asphalt.

Using this procedure it is shown that asphalts treated with the polymerized oil or blends thereof described in this invention have a lower ratio, thus showing a lower tendency for change in rheological properties as a result of oxidative aging and volatilization.

Accordingly, the polymerized oils described herein have been shown to be capable of rejuvenating aged asphalt binder, and restoring the rheological properties of a lesser aged asphalt binder. As a result, small dosages of the polymerized oil can be used to incorporate high content of aged recycled asphalt material into pavements and other applications resulting in significant economic saving and possible reduction in the environmental impact of the pavement through reduction of use of fresh resources.

Notably, the polymerized oil described herein may be used to make an emulsion for use in asphalt rejuvenation applications. The emulsion comprises an oil phase and an aqueous phase. The oil phase comprises the polymerized oil described herein and may further comprise of asphalt binder and other additives and modifiers, wherein the polymerized oil is about 0.1 to 100 wt % of the oil phase. The aqueous phase often comprises a surfactant and may further comprise natural and synthetic polymers (such as Styrene Butadiene Rubber and latex) and/or water phase thickeners.

The oil phase makes up about 15 to 85 wt % of the emulsion with the aqueous phase making up the remaining balance. It is understood by those skilled in the art that emulsions are sometimes further diluted with water at time of application, thus the effective oil phase content of the diluted emulsion may be reduced indefinitely.

Further contemplated herein is a method comprising applying the emulsion to the surface of an existing pavement or applying the emulsion to treat RAS or RAP and further mixing the treated RAS or RAP with virgin asphalt thereby obtaining a rejuvenated asphalt blend.

The emulsion may also be used as part of a cold patching material, a high performance cold patch or cold mix application that contains recycled asphalt thereby obtaining treated RAS or RAP.

In other aspects, the emulsion may be used for cold-in-place recycling of milled asphalt pavements or hot-in-place recycling of milled asphalt pavements.

### Thermoplastic Polymer Compatiblization in Asphalt

Asphalt is often modified with thermoplastic elastomeric and plastomeric polymers such as Styrene-Butadiene Styrene (SBS) as well as ground tire rubber to increase high temperature modulus and elasticity, to increase resistance to heavy traffic loading and toughening the asphalt matrix against damage accumulation through repetitive loading. Such polymers are usually used at 3 to 7 wt % dosages in the asphalt and can be as high as 20% for ground tire rubber. The polymer is high shear blended into asphalt at temperatures often exceeding 180° C. and allowed to “cure” at similar temperatures during which the polymer swells by adsorption of lighter fractions in the asphalt until a continuous volume phase is achieved in the asphalt.

The volume phase of the fully cured polymer will be affected by degree of compatibility of the polymer in the asphalt and the fineness of the dispersed particles, resulting in an increased specific area and enhanced swelling potential through increase of the interface surface between asphalt and polymer.

The polymerized oils described in this document have been shown to be capable of further compatibilizing thermoplastic polymer and ground tire rubber in the asphalt, when the oil is added and blended into the asphalt before the incorporation of the polymer, or the curing stage. This will be especially effective in asphalt binders that are not very compatible with the thermoplastic polymer. Furthermore, the oil may contribute to the lighter fractions that swell the polymers during the curing period.

### Warm Mix Additives and Asphalt

In recent years an increasing portion of pavements are use produced using what is commonly referred to as “warm mix additives” to produce “warm mix” asphalt pavements. Warm mix pavements can be produced and compacted at lower production temperatures, require less compaction effort to achieve target mixture density, and as a result can retain the properties necessary for compaction at lower temperature enabling an increase in the maximum haul distance of the asphalt mixture from the plant to the job site.

The different mechanisms through which warm mix additives may include increased lubrication of aggregates during asphalt mixture compaction, reduction of the binder viscosity at production temperatures, and better coating and wettability of the aggregates. Thus a diverse range of chemicals and additives may exhibit one or more of the properties attributed to warm mix additives when added to an asphalt mixture.

The polymerized oils described herein can be used as a warm mix additive and/or compaction aid, to achieve a number of the benefits expected from a warm mix additive including minimum decreasing production and construction temperatures through increase in aggregate lubrication and aggregate wettability. In such an application the additive would be used at dosages preferably in the range of between about 0.1 and 2% by weight of the bitumen.

### EXAMPLES

The following examples are presented to illustrate the present invention and to assist one of ordinary skill in making and using same. The examples are not intended in any way to otherwise limit the scope of the invention.

### Example 1: Blown Recovered Corn Oil #1

A modified asphalt binder comprising:
97.0% by weight of neat asphalt binder graded as PG64-22 (PG 65.7-24.9)
3.0% by weight of Cobalt Catalyzed (500 ppm) Blown Recovered Corn Oil, reacted at 115° C. for 3 hrs. This resulted in a modifier with:
   2.7% oligomer
   Polydispersity Index (PDI) of 1.03.
      The modifier was blended into the asphalt after the binder had been annealed at 150° C. for 1 hour. Performance grade tests were performed in accordance to AASHTO M320. The modification resulted in a 6.0° C. low temperature grade improvement, taking the neat binder grade of PG 64-22 to a PG 58-28. The net change in the high and low performance grade resulted in a Useful Temperature Interval was slightly decreased by 0.2° C. Details are shown in Table 1:

TABLE 1

| | | O- | R- | S- | |
|---|---|---|---|---|---|
| | UTI¹ | DSR² | DSR³ | BBR⁴ | m-BBR⁵ |
| Binder Name | ° C. | ° C. | ° C. | ° C. | ° C. |
| Unmodified | 90.6 | 65.69 | 65.8 | −24.9 | −26.5 |
| +3% Blown Recovered | 90.4 | 59.49 | 59.8 | −30.9 | −31 |
| Corn Oil #1 | | | | | |

¹UTI: Useful Temperature Interval, as the difference between the high temperature performance grade and the low temperature performance grade, as determined using AASHTO M320.
²O-DSR: The High Temperature Performance Grade of the Unaged (“Original”) asphalt binder as measured using a Dynamic Shear Rheometer (DSR) following ASTM D7175 and AASHTO M320.
³R-DSR: The High Temperature Performance Grade of the Rolling Thin Film Oven Aged (RTFO, following ASTM D2872) asphalt binder as measured using a Dynamic Shear Rheometer (DSR) following ASTM D7175 and AASHTO M320.
⁴S-BBR: The Low Temperature Performance Grade controlled by the Creep Stiffness parameter (“S”), as measured on an asphalt binder conditioned using both the Rolling Thin Film Oven (ASTM D2872) and Pressure Aging Vessel (ASTM D6521), using a Bending Beam Rheometer following ASTM D6648 and AASHTO M320.
⁵m-BBR: The Low Temperature Performance Grade controlled by the Creep Rate parameter (“m” value), as measured on an asphalt binder conditioned using both the Rolling Thin Film Oven (ASTM D2872) and Pressure Aging Vessel (ASTM D6521), using a Bending Beam Rheometer following ASTM D6648 and AASHTO M320.

### Example 2: Blown Recovered Corn Oil #2

A modified asphalt binder comprising:
97.0% by weight of neat asphalt binder graded as PG64-22 (PG 65.7-24.9)
3.0% by weight of Cobalt Catalyzed (500 ppm) Blown Recovered Corn Oil, reacted at 115° C. for 9 hrs. This resulted in a modifier with:
   231% oligomer
   PDI of 1.20
      The modifier was blended into the asphalt after the binder had been annealed at 150° C. for 1 hour. Performance grade tests were performed in accordance to AASHTO M320. The modification resulted in a 5.3° C. low temperature grade improvement, taking the neat binder grade of PG 64-22 to a PG 58-28. The net change in the high and low performance grade resulted in no change in the Useful Temperature Interval. Details are shown in Table 2:

TABLE 2

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 90.6 | 65.69 | 65.8 | −24.9 | −26.5 |
| +3% Blown Recovered | 90.6 | 60.37 | 60.47 | −30.2 | −32.5 |
| Corn Oil #2 | | | | | |

### Example 3: Blown Recovered Corn Oil #3

A modified asphalt binder comprising:
97.0% by weight of neat asphalt binder graded as PG64-22 (PG 65.7-24.9)
3.0% by weight of Cobalt Catalyzed (500 ppm) Blown Recovered Corn Oil, reacted at 115° C. for 16 hrs. This resulted in a modifier with:
   44.6% oligomer
   PDI of 1.99
      The modifier was blended into the asphalt after the binder had been annealed at 150° C. for 1 hour. Performance grade tests were performed in accordance to AASHTO M320. The modification resulted in a 5.7° C. low temperature grade improvement, taking the neat binder grade of PG 64-22 to a PG 58-28. The net change in the high and low performance grade resulted in a significant increase of 0.9° C. in the Useful Temperature Interval. Details are shown in Table 3:

TABLE 3

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 90.6 | 65.69 | 65.8 | −24.9 | −26.5 |
| +3% Blown Recovered | 91.5 | 60.93 | 61.01 | −30.6 | −31.3 |
| Corn Oil #3 | | | | | |

### Example 4: Blown Recovered Corn Oil #4

A modified asphalt binder comprising:
97.0% by weight of neat asphalt binder graded as PG64-22 (PG 64.9-24.7)
3.0% by weight of Cobalt Catalyzed (500 ppm) Blown Recovered Corn Oil, reacted at 115° C. for 9 hrs. This resulted in a modifier with:
   17.7% oligomer
   PDI of 1.13
   55 cSt at 40° C.
      The modifier was blended into the asphalt after the binder had been annealed at 150° C. for 1 hour. Performance grade tests were performed in accordance to AASHTO M320. The modification resulted in a 5.8° C. low temperature grade improvement, taking the neat binder grade of PG 64-22 to a PG 58-28. The net change in the high and low performance grade resulted in an increase of 0.3° C. in the Useful Temperature Interval. Details are shown in Table 4:

TABLE 4

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown Recovered | 89.9 | 59.43 | 60.39 | −30.5 | −33.9 |
| Corn Oil #4 | | | | | |

### Example 5: Blown Crude Palm Oil #1

A modified asphalt binder comprising:
97.0% by weight of neat asphalt binder graded as PG64-22 (PG 64.9-24.7)
3.0% by weight of Blown Crude Palm Oil, blown at 115° C. for 16 hrs. This resulted in a modifier with:
   26.7% oligomer
   PDI of 1.32.
      The modifier was blended into the asphalt after the binder had been annealed at 150° C. for 1 hour. Performance grade tests were performed in accordance to AASHTO M320. The modification resulted in a 5.4° C. low temperature grade improvement, taking the neat binder grade of PG 64-22 to a PG 58-28. The net change in the high and low performance grade resulted in a 0.4° C. decrease in the Useful Temperature Interval. Details are shown in Table 5:

TABLE 5

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown Crude Palm Oil #1 | 89.2 | 59.06 | 60.19 | −30.1 | −30.9 |

### Example 6: Blown and Stripped Recovered Corn Oil #1

A modified asphalt binder comprising:
97.0% by weight of neat asphalt binder graded as PG64-22 (PG 64.9-24.7)
3.0% by weight of Blown & Stripped Recovered Corn Oil, blown at 115° C. for 18 hrs, followed by a stripping process at 230° C. for 8 hrs. This resulted in a modifier with:
   68.7% oligomer
   PDI of 2.49.
   520 cSt at 40° C.
      The modifier was blended into the asphalt after the binder had been annealed at 150° C. for 1 hour. Performance grade tests were performed in accordance to AASHTO M320. The modification resulted in a 4.1° C. low temperature grade improvement, taking the neat binder grade of PG 64-22 to a PG 58-28. The net change in the high and low performance grade resulted in a 0.3° C. improvement in the Useful Temperature Interval. Details are shown in Table 6:

TABLE 6

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown & Stripped Recovered | 89.9 | 61.07 | 62.06 | −28.8 | −34.5 |
| Corn Oil #1 | | | | | |

### Example 7: Blown and Stripped Recovered Corn Oil #2 in a PG58-28 Bitumen

A modified asphalt binder comprising:
97.0% by weight of neat asphalt binder graded as PG58-28 (PG 60.5-29.2)
3.0% by weight of Blown & Stripped Recovered Corn Oil, blown at 115° C. for 12 hrs, followed by a stripping process at 230° C. for 7 hrs. This resulted in a modifier with:
   6.2% oligomer
   PDI of 1.03.
   67 cSt at 40° C.
      The modifier was blended into the asphalt after the binder had been annealed at 150° C. for 1 hour. Performance grade tests were performed in accordance to AASHTO M320. The modification resulted in a 5.7° C. low temperature grade improvement, taking the neat binder grade of PG 58-28 to a PG 52-34. The net change in the high and low performance grade resulted in a 0.2° C. improvement in the Useful Temperature Interval. Details are shown in Table

TABLE 7

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.0 | 60.51 | 59.8 | −29.2 | −29.8 |
| +3% Blown & Stripped Recovered | 89.2 | 54.47 | 54.29 | −34.9 | −35.2 |
| Corn Oil #2 | | | | | |

### Example 8: Blown and Stripped Recovered Corn Oil #2 in a PG64-22 Bitumen

A modified asphalt binder comprising:
97.0% by weight of neat asphalt binder graded as PG64-22 (PG 68.1-23.4)
3.0% by weight of Blown & Stripped Recovered Corn Oil, blown at 115° C. for 12 hrs, followed by a stripping process at 230° C. for 7 hrs. This resulted in a modifier with:
   6.2% oligomer
   PDI of 1.03.
   67 cSt at 40° C.
      The modifier was blended into the asphalt after the binder had been annealed at 150° C. for 1 hour. Performance grade tests were performed in accordance to AASHTO M320. The modification resulted in a 7.4° C. low temperature grade improvement, taking the neat binder grade of PG 64-22 to a PG 58-28. The net change in the high and low performance grade significantly improved the Useful Temperature Interval by 1.1° C. Details are shown in Table 8:

TABLE 8

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 91.5 | 68.11 | 68.53 | −26.1 | −23.4 |
| +3% Blown & Stripped Recovered | 92.6 | 61.78 | 62.46 | −30.8 | −31.2 |
| Corn Oil #2 | | | | | |

### Example 9: Blown Soybean Oil #1

A modified asphalt binder comprising:
97.0% by weight of neat asphalt binder graded as PG64-22 (PG 64.9-24.7)
3.0% by weight of none-catalyzed Blown Soybean Oil, reacted at 110° C. for 60 hrs. This resulted in a modifier with:
   66.2% oligomer
   PDI of 15.9.
   680 cSt at 40° C.
      The modifier was blended into the asphalt after the binder had been annealed at 150° C. for 1 hour. Performance grade tests were performed in accordance to AASHTO M320. The modification resulted in a 3.3° C. low temperature grade improvement, taking the neat binder grade of PG 64-22 to a PG 58-28. The net change in the high and low performance grade resulted in a 0.4° C. improvement in the Useful Temperature Interval. Details are shown in Table 9:

TABLE 9

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown Soybean Oil #2 | 90.0 | 61.99 | 62.74 | −28 | −29.9 |

### Example 10: Blown Soybean Oil Blend #1

A modified asphalt binder comprising:
97.0% by weight of neat asphalt binder graded as PG58-28 (PG 58.9-29.6)
3.0% by weight of a blend consisting of:
   78.1% by weight of cobalt catalyzed (250 ppm) blown soybean oil, reacted for 29 hr at 113° C.
   21.9% by weight of refined soybean oil
   Blend of the blown oil and the unmodified oil had a 51.1% oligomer content and a PDI of 6.33.
      The modifier was blended into the asphalt after the binder had been annealed at 150° C. for 1 hour. Performance grade tests were performed in accordance to AASHTO M320. The modification resulted in a 4.0° C. low temperature grade improvement. The net change in the high and low performance grade resulted in a 0.3° C. improvement in the Useful Temperature Interval. Details are shown in Table 10:

TABLE 10

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 88.5 | 58.91 | 59.94 | −29.6 | −30.1 |
| +3% Blown Soybean Oil Blend #1 | 88.8 | 55.23 | 55.91 | −33.6 | −35.2 |

### Example 11: Blown and Stripped Recovered Corn Oil Blend #2

A modified asphalt binder comprising:
97.0% by weight of neat asphalt binder graded as PG64-22 (PG 64.9-24.7)
3.0% by weight of a blend consisting of:
   44.4% by weight of the blown and stripped recovered corn oil #1.
   55.6% by weight of refined soybean oil
   Blend of the blown oil and the unmodified oil had a 31.15% oligomer content and a PDI of 3.81.
      The modifier was blended into the asphalt after the binder had been annealed at 150° C. for 1 hour. Performance grade tests were performed in accordance to AASHTO M320. The modification resulted in a 5.0° C. low temperature grade improvement, taking the neat binder grade of PG 64-22 to a PG 58-28. The net change in the high and low performance grade resulted in a 0.2° C. decrease in the Useful Temperature Interval. Details are shown in Table 11:

TABLE 11

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown and Stripped Recovered | 89.4 | 59.68 | 60.81 | −29.7 | −30.8 |
| Oil Blend #2 | | | | | |

### Example 12: Blown and Stripped Recovered Corn Oil Blend #3

A modified asphalt binder comprising:
97.0% by weight of neat asphalt binder graded as PG64-22 (PG 64.9-24.7)
3.0% by weight of a blend consisting of:
   74.0% by weight of the blown and stripped recovered corn oil #1.
   26.0% by weight of refined soybean oil
   Blend of the blown oil and the unmodified oil had a 51.6% oligomer content and a PDI of 4.02.
      The modifier was blended into the asphalt after the binder had been annealed at 150° C. for 1 hour. Performance grade tests were performed in accordance to AASHTO M320. The modification resulted in a 4.6° C. low temperature grade improvement, taking the neat binder grade of PG 64-22 to a PG 58-28. The net change in the high and low performance grade resulted in a 0.3° C. improvement in the Useful Temperature Interval. Details are shown in Table 12:

TABLE 12

| | | O- | R- | S- | m- |
|---|---|---|---|---|---|
| | UTI | DSR | DSR | BBR | BBR |
| Binder Name | ° C. | ° C. | ° C. | ° C. | ° C. |
| Unmodified | 89.6 | 64.88 | 65.88 | −25.8 | −24.7 |
| +3% Blown and Stripped Recovered | 89.9 | 60.63 | 61.30 | −29.3 | −30.3 |
| Oil Blend #3 | | | | | |

### Example 13: Asphalt Modified with Styrene Butadiene Styrene and Blown Recovered Corn Oil #4 as a Compatibilizer

A modified asphalt binder comprising:
92.41% by weight of neat asphalt binder graded as PG64-22
5.5% by weight of Linear Styrene Butadiene Styrene (SBS)
0.09% by weight of Elemental Sulfur (used as an SBS cross linker in the asphalt binder
2.0% by weight of a blown recovered corn oil (RCO) as descried in Example #4.

### Blending Procedure:

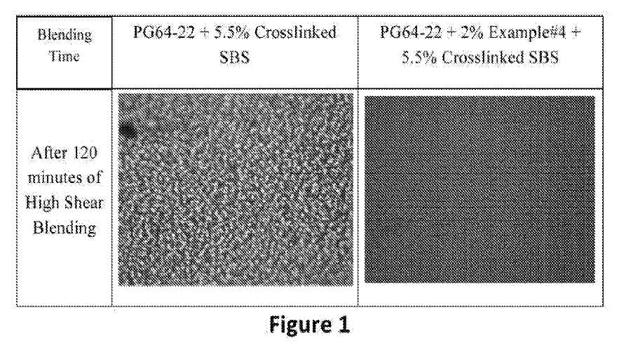

1. The modifier was blended into the asphalt after the binder had been annealed at 150° C. for 1 hour. The modified binder heated to about 193° C. for polymer modification.
2. The RPM in the high shear mixer was set to 1000 while the SBS was added (within 1 minute). Immediately after addition of the polymer the RPM was briefly ramped up to 3000 rpm for approximately 10 minutes to insure full break down of the SBS pellets, after which the shear level was lowered to 1000 rpm.
3. Polymer blending was continued at 1000 rpm for a total of 2 hrs.
4. Temperature was dropped to about 182° C. at a 150 rpm at which point the sulfur cross linker was added.
5. Blending was continued at 182° C. and 150 rpm for 2 hrs.
6. Polymerized binder was placed in an oven at 150° C. for approximately 12-15 hrs (overnight) to achieve full swelling of the polymer.
   Performance grade tests were performed in accordance to AASHTO M320. Multiple Stress Creep and Recovery tests were performed on the RTFO residue at 64° C. in accordance to AASHTO T350. The results show that despite the significant reduction in modulus the average percent of recovery of the binder was maintained for the binder containing the modifier, indicating the effect of the modifier as a compatibilizer of SBS, resulting in a better distribution of the same mass of the elastomeric polymer compared to the binder that did not contain the modifier and consequently a more efficient elastic network. Details are shown in Table 13. The images in FIG. 1, taken using an Olympus BX43 UV Fluorescence microscope (100× magnification), clearly show the fine and uniform distribution of the SBS polymer (the lighter phase) in the bitumen after addition of the Example #4 modifier as a compatibilizer compared to the blend that did not contain a compatibilizer, after being subjected to identical mixing conditions.

TABLE 13

| | | | MSCR at 3.2 kPa |
|---|---|---|---|
| | DSR \|G*\|/sinδ | | Recovery at 64° C. |
| | Unaged | | (RTFO) |
| Binder Name | 70° C. | 76° C. | (%) |
| +5.5% Crosslinked SBS | 4.05 | 2.51 | 89.0% |
| +2% Example#4 + 5.5% | 2.70 | 1.69 | 90.0% |
| Crosslinked SBS | | | |

### Example #14: Effect of Free Fatty Acid Content

A set of samples were prepared in which different dosages of Oleic acid (C18:1) was blended into a refined soybean oil. The purpose of the experiment was to demonstrate the adverse effect of the free fatty acid (as represented by the added Oleic acid content in this example) on the flashpoint and aging characteristics of the oil. Table 14 shows the effect of the added oleic acid on the open cup flashpoint:

TABLE 14

| | Added Oleic Acid | Open cup |
|---|---|---|
| Base Oil Content | Content | Flashpoint |
| 100% SBO | 0% Added Oleic Acid | 314° C. |
| 90% SBO | 10% Added Oleic Acid | 242° C. |
| 75% SBO | 25% Added Oleic Acid | 224° C. |
| 45% SBO | 55% Added Oleic Acid | 208° C. |

Using the oil and oleic acid blends described above, a set of modified asphalt binder comprising the following was made:
97.0% by weight of neat asphalt binder graded as PG64-22 (PG 64.9-24.7)
The modifier blended into the asphalt after the binder had been annealed at 150° C. for 1 hour.

Short term aging was performed using a Rolling Thin Film oven (RTFO) at 163° C. for 85 minutes in accordance to ASTM D2872. The procedure is used to simulate the oxidation and volatilization that occurs in the asphalt terminal when the binder is heated and applied to the aggregate. The RTFO conditioning increases the complex modulus through oxidation and volatilization, as measured using the Dynamic Shear Rheometer parallel plate geometry (25 mm diameter, 1 mm gap) in accordance to ASTM D7175.

The results shown in Table 15 demonstrate a significant increase in the ratio of |G*|/sin δ after aging to that before aging, indicating a higher amount of “age hardening” in the asphalt binder as the free fatty acid content increased. The nearly linear relationship between the increase in the oleic acid content and the increase volatile mass loss also indicates the volatility of the oleic acid at the high temperature and flow rates that the binder is exposed to during RTFO aging. These results indicate the desirability of using low free fatty acid base oils and stripping of the free fatty acid in oils with higher free fatty acid content. Furthermore, stripping to further reduce the free fatty acid content consequently reduces acid value which aids in preventing negative reactions with amine antistrips.

TABLE 15

| | | Unaged | | | Aging | RTFO |
|---|---|---|---|---|---|---|
| | Added Oleic | \|G*\|/sinδ | RTFO Aged | | Increase | Volatile |
| Base Oil | Acid | at 64° C. | \|G*\|/sinδ at | Ratio of | in | Mass |
| Content | Content | (kPa) | 64° C. (kPa) | RTFO/Unaged | \|G*\|/sinδ | Loss |
| 100% | 0% Added | 0.56 | 1.33 | 2.37 | 137.1% | 0.390% |
| SBO | Oleic Acid | | | | | |
| 90% | 10% Added | 0.54 | 1.33 | 2.46 | 145.8% | 0.457% |
| SBO | Oleic Acid | | | | | |
| 75% | 25% Added | 0.53 | 1.35 | 2.55 | 154.8% | 0.545% |
| SBO | Oleic Acid | | | | | |
| 45% | 55% Added | 0.52 | 1.35 | 2.58 | 157.6% | 0.688% |
| SBO | Oleic Acid | | | | | |

### Example #15: Cationic Emulsion of Asphalt Containing Blown Oil of Example #4

A modified asphalt binder comprising:
95.0% by weight of neat asphalt binder graded as PG64-22 (PG 64.88-24.7)
5.0% by weight of a the Blown oil described in Example #4.
   The modifier was blended into the asphalt after the binder had been annealed at 150° C. for 1 hour. The modified asphalt was used as the oil component to make a latex modified cationic rapid set emulsion. The oil phase was 65.0% by total weight of the emulsion. The aqueous phase consisted of the following components:
0.70% by weight of emulsion of a cationic quick set imidazoline emulsifier (Anova 1620 manufactured by Cargill)
2.0% by weight of emulsion of Latex (UltraPave)
HCl in sufficient content to achieve a pH of 2.6
   Incorporation of the polymerized oil in this formulation enables use of this product in rejuvenating surface applications used for pavement maintenance and preservation, especially rejuvenating scrub seal applications, and rejuvenating fog seals and sand seals. Furthermore, the emulsified solution enables use in low unheated paving applications (known as “Cold Mixes”) such as cold in place recycling, cold patch, and cold mix pavement layers. Use of emulsifier formulations with different set time quickness, enables control of the rate of increase in aggregate retention and traffic resistance. For example, in ideal rapid set conditions the road can be opened to traffic within 30 minutes to an hour of the application. The content of polymerized oil will vary depending on the grade of the base oil and the final desired properties.

1. A method for polymerizing a biorenewable oil, the method comprising:
(a) heating the oil to at least 90° C.; and
(b) exposing an oxygen containing stream to the heated oil to produce a blown, polymerized oil with a polymeric distribution having about 2 to about 80 wt % oligomer content and a polydispersity index ranging from about 1.10 to about 12.0.

2. The method of claim 1, further comprising adding a first base metal catalyst to the oil before, during or after step (a);

3. The method of claim 2, wherein the first base metal catalyst is selected from the group consisting of cobalt, iron, zirconium, lead, and combinations thereof.

4. The method of claim 1, furthering comprising stripping the blown oil to produce a blown and stripped, polymerized oil.

5. The method of claim 2, further comprising adding a second base metal catalyst before or during stripping step, wherein the second base metal catalyst is different from the first base metal catalyst.

6. The method of claim 1, wherein the oxygen containing stream is an oxygen enriched stream derived from air.

7. The method of claim 1, wherein the oligomer content ranges from about 15 to about 60 wt %.

8. The method of claim 1, wherein the polydispersity index ranges from about 1.2 to about 5.0.

9. The method of claim 1, wherein the blown, polymerized oil has a flash point ranging from about 100° C. to about 400° C.

10. The method of claim 1, wherein the blown, polymerized oil has a flash point ranging from about 200° C. to about 350° C.

11. The method of claim 1, wherein the blown, polymerized oil has a flash point ranging from about 245° C. to about 275° C.

12. A modified asphalt comprising the polymerized oil made according to claim 1.

13. A modified asphalt for use in compositions for paving roads comprising the polymerized oil made according to claim 1.

14. A modified asphalt for use in compositions for roofing materials comprising the polymerized oil made according to claim 1.

15. A rejuvenator for use in asphalt comprising polymerized oil made according to claim 1.

16. A performance grade modifier for use in asphalt comprising polymerized oil made according to claim 1.

17. A compatibilizer and swelling agent for use in asphalt comprising polymerized oil made according to claim 1.

18. A warm mix additive for use in asphalt comprising polymerized oil made according to claim 1.

19. A modified asphalt comprising:
(a) about 60 to about 99.9 wt % asphalt binder; and
(b) about 0.1 to about 40 wt % polymerized oil, made by the following steps:
i. heating a biorenewable oil to about least 90° C.; and
ii. exposing an oxygen containing stream to the heated oil to produce a blown oil with a polymeric distribution having about 2 to about 80 wt % oligomer content and a polydispersity index ranging from about 1.10 to about 12.0.

20. The modified asphalt of claim 19, further comprising at least one from the group consisting of thermoplastic elastomeric and plastomeric polymers, polyphosphoric acid, anti-stripping additives, warm mix additives, emulsifiers, and fibers.

21. A method of incorporating a polymerized oil in asphalt applications, comprising:
(a) obtaining a polymerized oil, made by the following steps:
i. heating a biorenewable oil to at least 90° C.;
ii. exposing an oxygen containing stream to the heated oil to produce a blown oil with a polymeric distribution having about 2 to about 80 wt % oligomer content and a polydispersity index ranging from about 1.10 to about 12.0; and
(b) adding the polymerized oil to asphalt to be used in asphalt pavements thereby obtaining a modified asphalt; wherein the amount of the polymerized oil ranges from 0.1 to 40 wt % of the modified asphalt.

22.-42. (canceled)
